(19) United States
(12) Patent Application Publication
(10) Pub. No.: US 2026/0104864 A1
(43) Pub. Date: Apr. 16, 2026

(54) SCRIPT GENERATION APPARATUS AND SCRIPT GENERATION METHOD

(71) Applicant: Hitachi Vantara, Ltd., Kanagawa-ken (JP)

(72) Inventors: Soichi WATANABE, Tokyo (JP); Mitsuo HAYASAKA, Tokyo (JP); Keiichi MATSUZAWA, Tokyo (JP)

(21) Appl. No.: 19/330,440

(22) Filed: Sep. 16, 2025

(30) Foreign Application Priority Data
Oct. 11, 2024 (JP) 2024-178650

(51) Int. Cl. G06F 8/35; G06F 8/36

(52) U.S. Cl. CPC G06F 8/35; G06F 8/36

(57) ABSTRACT

A computing machine that generates a script for setting a predetermined high-level function for a predetermined device includes a storage device, a memory, and a CPU. The memory is configured to store an API code database that stores codes of a plurality of APIs for setting each of a plurality of low-level functions, and the CPU that has received, from a user, a request for setting of a high-level function realized by using a plurality of low-level functions is configured to retrieve and acquire codes of a plurality of APIs used for setting a plurality of low-level functions in response to the request from the database, create a high-level function script for setting the high-level function by using the acquired codes of the plurality of APIs, and set a parameter of the high-level function script based on an input of the user, and issue the high-level function script.

### CROSS REFERENCE TO RELATED APPLICATION

This application relates to and claims the benefit of priority from Japanese Patent Application number 2024-178650, filed on Oct. 11, 2024 the entire disclosure of which is incorporated herein by reference.

### BACKGROUND OF THE INVENTION

### 1. Field of the Invention

The present invention relates to a technique for generating a script for performing setting on a device.

### 2. Description of the Related Art

For example, a chatbot that performs a chat on behalf of a human is known. Construction of the chatbot is difficult, and it takes time to correctly implement the chatbot.

For example, U.S. Pat. No. 10,388,285 discloses a technique for automatically generating a chatbot for an application programming interface (API). Here, the API is an interface for operating and setting a certain function of a certain device from a program.

### SUMMARY OF THE INVENTION

In the technique disclosed in U.S. Pat. No. 10,388,285, it is effective if a function desired by a user of the chatbot and an API for setting this function are in one-to-one correspondence. On the other hand, when a plurality of APIs are necessary for setting a function desired by the users of the chatbot, the users need to have a dialogue with the chatbot in accordance with an appropriate procedure for the necessary API. Therefore, there is a problem that it is not possible for a user who does not understand a setting procedure by a plurality of APIs in setting a desired function to appropriately perform setting.

The present invention has been made in view of the above circumstances, and an object of the present invention is to provide a technique for assisting in easily and appropriately creating a script for performing desired setting.

To achieve the above object, according to an aspect, a script generation apparatus assists generation of a script for setting a predetermined high-level function for a predetermined device. The script generation apparatus includes a storage and a processor. The storage is configured to store a database that stores codes of a plurality of APIs for setting each of a plurality of low-level functions, and the processor that has received, from a user, a request for setting of a high-level function realized by using a plurality of low-level functions is configured to retrieve and acquire codes of a plurality of APIs used for setting a plurality of low-level functions in response to the request from the database, create a high-level function script for setting the high-level function by using the acquired codes of the plurality of APIs, and set a parameter of the high-level function script based on an input of the user, and issues the high-level function script.

According to the present invention, it is possible to provide a technique capable of easily and appropriately creating a script for performing desired setting.

### BRIEF DESCRIPTION OF THE DRAWINGS

FIG. 1 is a diagram illustrating an outline of processing of a computing machine according to a first embodiment;

FIG. 2 is a configuration diagram of the computing machine according to the first embodiment;

FIG. 3 is a diagram illustrating an example of an API specification according to the first embodiment;

FIG. 4 is a configuration diagram of an example of an API code database according to the first embodiment;

FIG. 5 is a configuration diagram of an example of a scenario definition according to the first embodiment;

FIG. 6 is a configuration diagram of an example of an intent definition according to the first embodiment;

FIG. 7 is a configuration diagram of an example of an entity-slot definition according to the first embodiment;

FIG. 8 is a configuration diagram of an example of a response definition according to the first embodiment;

FIG. 9 is a configuration diagram of an example of a script database according to the first embodiment;

FIG. 10 is a flowchart of setting procedure extraction processing according to the first embodiment;

FIG. 11 is a flowchart of script generation processing according to the first embodiment;

FIG. 12 is a flowchart of chatbot setting processing according to the first embodiment;

FIG. 13 is a flowchart of action code generation processing according to the first embodiment;

FIG. 14 is a flowchart of chatbot processing according to the first embodiment;

FIG. 15 is a diagram illustrating a dialogue between an operation manager and a chatbot according to the first embodiment;

FIG. 16 is a diagram illustrating an outline of processing of a computing machine according to a second embodiment;

FIG. 17 is a configuration diagram of setting procedure information according to the second embodiment;

FIG. 18 is a configuration diagram of an example of an API specification database according to the second embodiment;

FIG. 19 is a flowchart of chatbot setting processing according to the second embodiment; and

FIG. 20 is a flowchart of action code generation processing according to the second embodiment.

### DESCRIPTION OF THE PREFERRED EMBODIMENTS

Embodiments will be described with reference to the drawings. The embodiments described below do not limit the invention according to the claims, and all the elements and combinations described in the embodiments are not necessarily essential for the solution of the invention.

In the following description, there is a case where processing is described with a “program” as an operation entity, but the program is executed by a processor to perform determined processing appropriately using at least one of a storage and an interface device, and thus the operation entity of the processing may be set to be the processor (alternatively, a computing machine or a computing machine system including the processor). The program may be installed on the computing machine from a program source. The program source may be, for example, a program distribution server or a computing machine-readable recording medium. In the following description, two or more programs may be realized as one program, or one program may be realized as two or more programs. At least a part of the processing realized by executing the program may be realized by a hardware circuit (for example, an application specific integrated circuit (ASIC) or a field-programmable gate array (FPGA)).

### First Embodiment

A computing machine according to a first embodiment uses, for example, a manual of a device intended to be operated by a user and an API specification of the device, generates a script for setting a function that needs to be set by executing a plurality of APIs in the device, acquires setting values of parameters necessary for the script while transmitting an inquiry to the user, writes the setting values into the script, and outputs the script to the user.

Here, the API specification is a document indicating definitions of input/output parameters and attributes for each API for operating a device from a program. As the API specification, for example, there is a specification conforming to SWAGGER. In the following description, a specification conforming to SWAGGER will be described as an example of the API specification, and the API specification is not limited thereto.

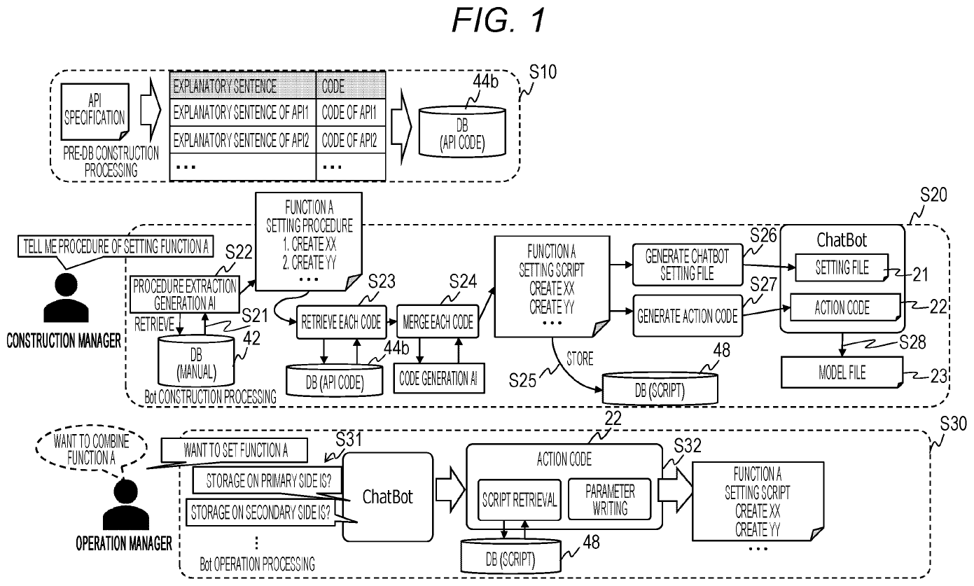

FIG. 1 is a diagram illustrating an outline of processing of the computing machine according to the first embodiment.

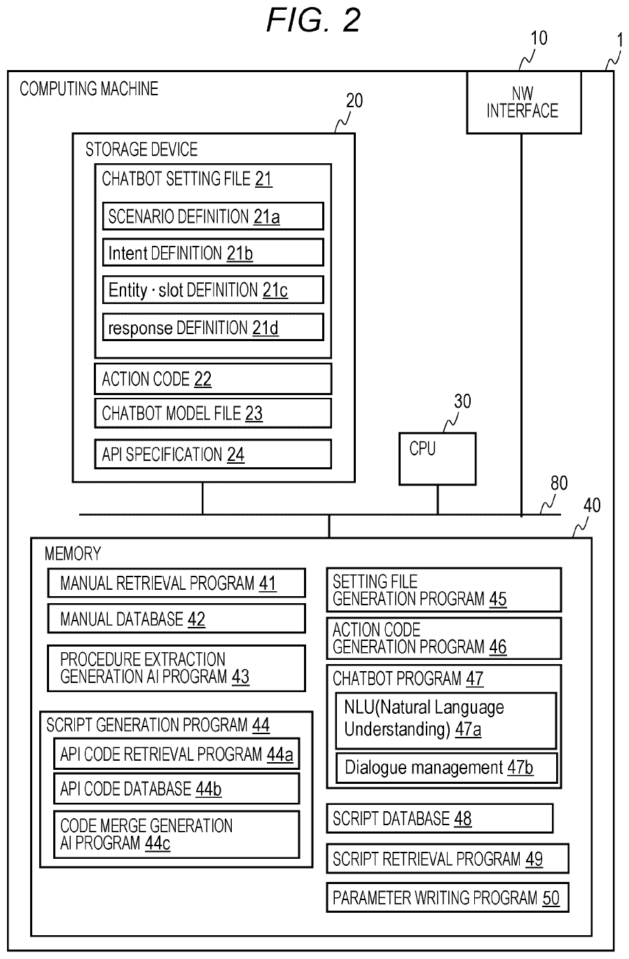

The computing machine 1 (see FIG. 2) according to the first embodiment roughly executes pre-DB construction processing S10, bot construction processing S20, and bot operation processing S30.

In the pre-DB construction processing S10, the computing machine 1 constructs an API code database 44b from the API specification. The API code database 44b is, for example, a database that manages a set of a key and a value, the key is an API explanatory sentence, and the value is a code (API code) that executes an API corresponding to an API explanatory sentence of key.

Although the API explanatory sentence is illustrated as an explanatory sentence using a natural language expression in FIG. 1, for example, the explanatory sentence of the natural language expression may be a numerical value obtained by vectorization using a predetermined language model. Here, as the language model, Word2Vec, BERT, text-embedding-ada-002 can be used, and other existing language models or newly developed language models may be used.

The bot construction processing S20 is processing that is executed by the computing machine 1 according to an operation by a construction manager being a user who constructs a chatbot (also simply referred to as a bot).

Here, the construction manager is, for example, a manager skilled in the specification of an API of a device.

The computing machine 1 receives, for example, an instruction to request extraction of a procedure for setting a certain function (for example, function A) of the device from the construction manager, and retrieves a sentence indicating a setting procedure of the requested function from a manual database 42 constructed in advance (S21). Here, the sentence indicating the setting procedure of the function is, for example, a sentence in a page indicating the setting procedure of the function in the API manual of the device.

The computing machine 1 inputs a sentence indicating the setting procedure of the function obtained by the retrieval to a procedure extraction generation artificial intelligence (AI) to summarize the sentence, and outputs the setting procedure of the function to a construction screen in an itemized form, for example (S22). Then, the computing machine 1 receives the setting procedure in the itemized form from the construction manager via the construction screen, generates a template of a script for executing each setting procedure for setting a function based on the received setting procedure (S23 and S24), and inputs the template to a script database 48 (S25).

Specifically, the computing machine 1 acquires a code (API code) of an API for setting each received setting procedure from the API code database 44b (S23), and merges a plurality of acquired codes with a code generation AI to generate the template of the script for executing each setting procedure for setting the function (S24). Here, as a unit of merging the codes, for example, the codes of all the setting procedures may be merged, or the codes may be merged using, as a unit, a setting procedure of a function (middle-level function) that constitutes a requested high-level function and has a middle level. The middle-level function may be specified by the computing machine 1 or may be received from the construction manager.

Then, the computing machine 1 displays the template of the script on the construction screen, receives the template of the script as a target of setting a chatbot from the construction manager, and generates and outputs a chatbot setting file 21 and an action code 22 (S26 and S27). The computing machine 1 generates a chatbot model file 23 from the chatbot setting file 21 (S28).

The bot operation processing S30 is processing executed by the computing machine 1 according to an operation by the operation manager being a user who operates a device by using a bot. In the bot operation processing S30, for example, even if the operation manager is unfamiliar with the specification of the API of the device, the operation manager can set a high-level function of the device without any trouble.

The computing machine 1 configures a chatbot, has a dialogue with the operation manager via a bot screen by the chatbot, receives setting of a desired function from the operation manager, and then sequentially asks for setting values of parameters necessary for the setting of the received function (S31). When the computing machine 1 can acquire answers about the setting values of all the parameters, the computing machine 1 executes the action code 22 (S32). The computing machine 1 that executes the action code 22 retrieves a script for setting the function from the script database 48, and writes the setting value of the parameter acquired from the operation manager into the script and outputs the script. Here, as a method of outputting the script, a URL storing the script may be output without outputting the script itself.

FIG. 2 is a configuration diagram of the computing machine according to the first embodiment.

The computing machine 1 is an example of a script generation apparatus, and includes, for example, a computer such as a personal computer (PC) or a general-purpose server. The computing machine 1 includes one or more central processing units (CPUs) 30, one or more memories 40, one or more storage devices 20, and one or more network (NW) interfaces 10. These constituent elements are connected via a bus 80 capable of bidirectional communication. Here, the memory 40 and/or the storage device 20 is an example of a storage. The computing machine 1 is not limited to the physical configuration described above, and may have, for example, a virtual configuration using a virtualization technique such as a virtual machine or a container. The computing machine 1 may include a plurality of physical computing machines.

The network interface 10 is an interface for communicating with a device outside the computing machine 1 via a network (not illustrated). The network interface 10 may include any network device according to an external communication standard.

The CPU 30 is an example of a processor, and executes various types of processing by executing various programs stored in the memory 40.

An example of the memory 40 includes a dynamic random access memory (DRAM). The memory 40 stores various programs and data of various databases. Specifically, the memory 40 stores a manual retrieval program 41, a manual database 42, a procedure extraction generation AI program 43, a script generation program 44, a setting file generation program 45, an action code generation program 46, a chatbot program 47, a script database 48, a script retrieval program 49, and a parameter writing program 50.

The memory 40 may store data other than the illustrated data.

The manual retrieval program 41 is executed by the CPU 30 to perform processing of receiving, as an input, a character string such as a word/phrase, an article, or a sentence of a natural language expression, vectorizing the character string of the natural language expression, and retrieving a sentence corresponding to a key from the manual database 42 by using the vectorized value as the key. A language model can be used to vectorize the character string of the natural language expression. For example, the language model may be Word2Vec, BERT, or text-embedding-ada-002, or may be another language model or a newly developed language model.

The manual database 42 is a vector database made so that a character string of a natural language expression of the content of a manual (an example of setting procedure information) related to the setting for a device as a setting target can be vectorized and retrieved. In the example of FIG. 2, the manual database 42 is stored in the memory 40, but the present embodiment is not limited thereto, and the manual database 42 may be stored in the storage device 20. The manual database 42 may not be a vector database, and may be, for example, a database that enables keyword retrieval of the body of the manual, or may be a database that enables retrieval of the body of the manual by any other retrieval method. A language model can be used to vectorize the character string of the natural language expression of the content of the manual. For example, the language model may be Word2Vec, BERT, or text-embedding-ada-002, or may be another language model or a newly developed language model.

The procedure extraction generation AI program 43 is executed by the CPU 30 to perform processing of receiving the sentence of the manual retrieved by the manual retrieval program 41 and the name of a function set as a target and outputting the itemized form of the setting procedure of the function set as the target. A Large Language Model (LLM) used by the procedure extraction generation AI program 43 may be, for example, GPT-4, GPT-3,LlaMa2, or any other LLM. Addition of knowledge by Fine-tuning or additional learning may be performed for the LLM by using any type of data.

The script generation program 44 is executed by the CPU 30 to perform processing of receiving, as an input value, a character string of a natural language expression describing each of a plurality of APIs and generating a script for executing each API. The script generation program 44 includes an API code retrieval program 44a, an API code database 44b, and a code merge generation AI program 44c.

The API code retrieval program 44a is executed by the CPU 30 to receive, as an input value, a character string of a natural language expression describing each of the plurality of APIs, and retrieve the code of the API corresponding to the input value from the API code database 44b.

The API code database 44b is a database constructed by pre-database construction processing.

The code merge generation AI program 44c is executed by the CPU 30 to receive, as an input value, a plurality of API codes from the API code retrieval program 44a and output one script for executing a plurality of APIs by merging the codes. Here, the LLM used in the code merge generation AI program 44c may be, for example, CodeLLama, CodeLLama-python, CodeLLama-instruction, or any other LLM. Knowledge by Fine-tuning or additional learning may be added to the LLM by using any type of data.

The setting file generation program 45 is executed by the CPU 30 to receive a script for executing a plurality of APIs as an input, analyze a parameter used in the script, and generate a chatbot setting file 21 necessary for constructing a dialogue scenario for transmitting an inquiry of a setting value of each parameter to the user. Details of the chatbot setting file 21 will be described later.

The action code generation program 46 is executed by the CPU 30 to receive a script for executing a plurality of APIs as an input, analyze a parameter used in the script, and generate an action code 22 for setting a setting value to the parameter. The action code 22 is any program. Details of the action code 22 will be described later.

The chatbot program 47 is a program executed by the CPU 30 to configure a chatbot, and includes a natural language understanding (NLU) 47a and Dialogue management 47b. The NLU 47a is executed by the CPU 30 to perform processing of classification of intent, extraction of entity, acquisition of response, and storing of slot. The NLU is, for example, a model trained by machine learning, and classifies which intent is the natural language input by the user. The Dialogue management 47b is executed by the CPU 30 to perform processing of determining a next action of a dialogue between the user and the chatbot based on the context. In the present embodiment, the chatbot is constructed, for example, on RASA Open Source (also simply referred to as RASA). The RASA includes an NLU 47a and a Dialogue management 47b, and customizes the NLU 47a and the Dialogue management 47b by learning the chatbot setting file 21 on the storage device 20 and generates a chatbot model file 23. The chatbot may be constructed on any chatbot platform. The chatbot model file 23 is a file for recording the customized NLU 47a and Dialogue management 47b.

The chatbot program 47 recognizes the input value of the natural language expression from the user as intent, entity, and slot by the NLU 47a. The chatbot program 47 outputs response to the user along the context determined by the Dialogue management 47b. Details of intent, entity, slot, and response will be described later. The chatbot program 47 executes the action code 22 in accordance with the context determined by the Dialogue management 47b.

The script database 48 is, for example, a database that manages a set of a key and a value, the key is a value obtained by vectorizing a character string of a natural language expression including the name of each function of the device, and the value is a script for collectively executing an API for setting the function. A language model may be used to vectorize the character string of the natural language expression including the name of the device. The language model may be Word2Vec, BERT, or text-embedding-ada-002, or may be another language model or a newly developed language model. Details of the script database 48 will be described later.

The script retrieval program 49 is executed by the CPU 30 to receive a character string of a natural language expression indicating a function as a setting target, as an input value, and retrieves a script corresponding to the input value from the script database 48.

The parameter writing program 50 is executed by the CPU 30 to execute the action code 22 and perform processing of writing a setting value in the parameter in the script, on the script.

The storage device 20 is, for example, a non-volatile storage device such as a hard disk drive (HDD) or a solid state drive (SSD). The storage device 20 stores an operating system (OS) image, data for constructing a chatbot, API specifications, and the like. Specifically, the storage device 20 stores the chatbot setting file 21, the action code 22, the chatbot model file 23, and the API specification 24. The storage device 20 may store data other than illustrated data.

The chatbot setting file 21 is a file necessary for constructing a chatbot that executes a scenario for transmitting an inquiry of the setting value of each parameter in the script to the user. The chatbot setting file 21 includes a scenario definition 21a, an intent definition 21b, an Entity·slot definition 21c, and a response definition 21d.

The action code 22 is executed by the CPU 30 to set a setting value to a parameter used in the script.

The chatbot model file 23 is a file for recording the customized NLU 47a and Dialogue management 47b.

The API specification 24 is a document indicating definitions of input/output parameters and attributes for each API for operating a device from a program.

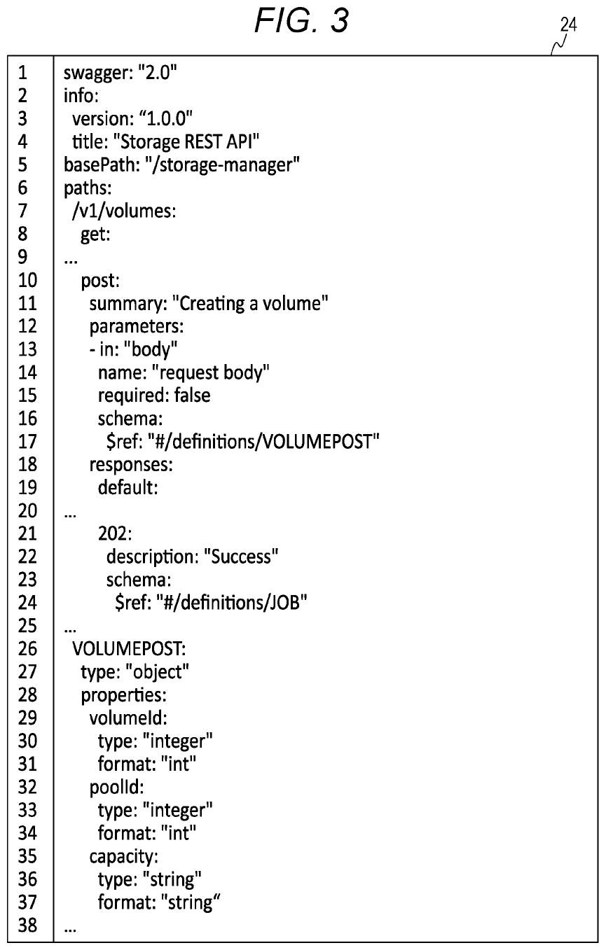

FIG. 3 is a diagram illustrating an example of the API specification according to the first embodiment.

The API specification 24 is a specification conforming to SWAGGER regarding a Storage REST API for managing a storage device as an example of the device.

In the first to third lines of the API specification 24, the version of SWAGGER and the version of the API are described. In the fourth line, the title of the API is described. In the fifth line, a base path of the API is described.

A resource (which is a resource operable in a storage, for example, a volume), an action (GET, POST, and the like), and a response (information of a return value after using the API) are described in up to the sixth to 25th lines of the API specification 24. In FIG. 3, for simplicity, only /v1/volumes is described in detail as the resource, and other resources are omitted. Only POST among actions for a path of /v1/volumes is illustrated in detail as the action. In FIG. 3, only one type of response is illustrated in detail.

In the example of FIG. 3, ref:

“#/definitions/VOLUMEPOST” in the 17th line is a type of a request body which is an input value of POST /v1/volumes, and indicates a reference to a type definition in VOLUMEPOST described in the 26th to 37th lines. In the Type definition in VOLUMEPOST, it is defined that setting values may be input for parameters of volumeId, poolId, and capacity. In the example of FIG. 3, only the type definition for POST of /v1/volumes is illustrated in detail, and others are omitted.

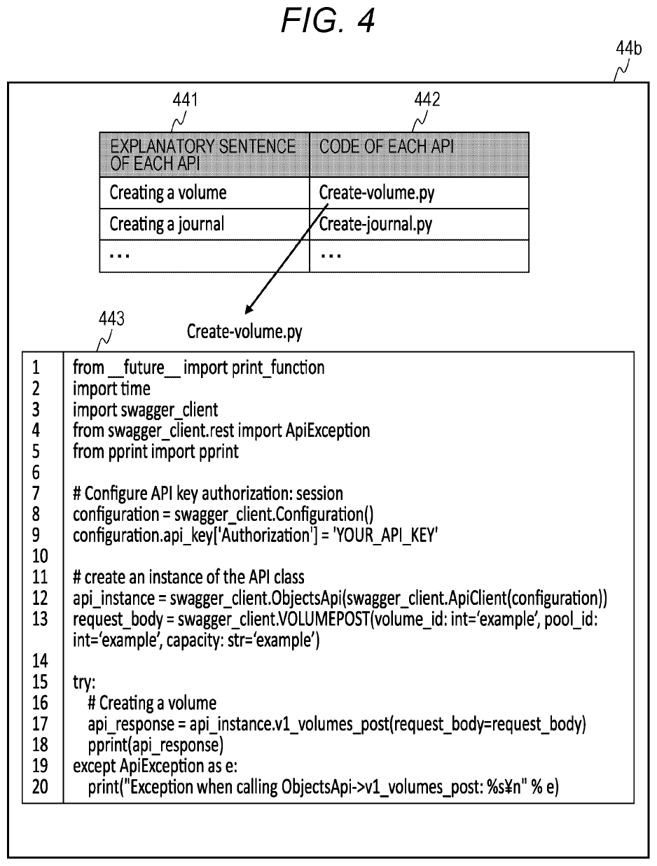

FIG. 4 is a configuration diagram of an example of the API code database according to the first embodiment.

The API code database 44b is created, for example, in the pre-DB construction processing. The API code database 44b stores an entry for each API described in the API specification.

The entry of the API code database 44b includes a key 441 and a value 442. The key 441 stores an explanatory sentence (an example of low-level function specifying information) of an API corresponding to the entry, which is a key. In the present embodiment, the explanatory sentence of the API may be a value obtained by vectorizing a character string of a natural language expression of the explanatory sentence of the API. The explanatory sentence of the API may be a summary in the API specification 24.

For example, the API for POST of /v1/volumes of the API specification 24 in FIG. 3 may use the value in the 11th line. Information other than the summary may be used as the explanatory sentence of the API.

In the value 442, a code that is a value and executes the API corresponding to the entry is stored. For example, a file 443 of a code whose file name is Create-volume.py is stored in the value 442 in the first entry.

In the file 443, a code for importing a necessary library is described in the first to fifth lines. In addition, in the seventh to ninth lines, a code for using an authentication and authorization mechanism of a device that executes the API is described. In the 11th to 13th lines, a code for setting an API instance and a parameter of a request body is described. In the 15th to 20th lines, a code for actually executing the API is described. The codes illustrated in FIG. 4 are an example, and other codes may be stored. For example, although the codes illustrated in FIG. 4 illustrate an example in which Python is adopted as a programming language, the codes may be written in any programming language. The code for executing the API may be manually created by the user, may be automatically generated by using the function of SWAGGER, or may be created by any other method.

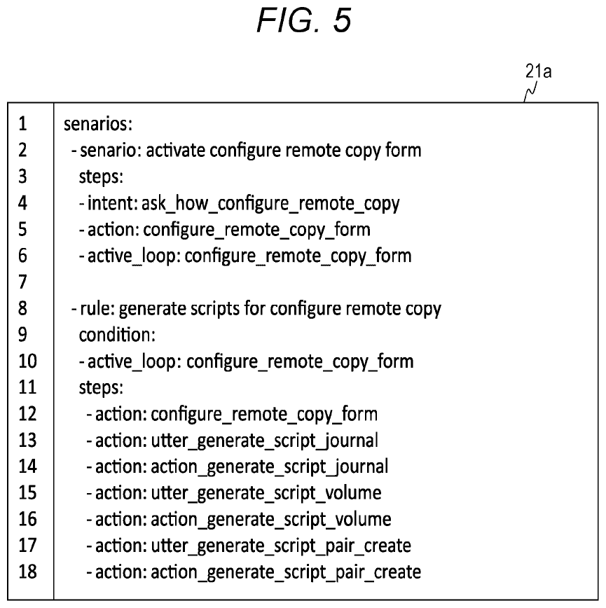

FIG. 5 is a configuration diagram of an example of the scenario definition according to the first embodiment.

The scenario definition 21a is information defining a scenario when the chatbot has a dialogue with the user.

In the scenario definition 21a illustrated in FIG. 5, a scenario name is described in the second line. In the fourth line, intent as a trigger for activating the scenario is described. Details of Intent will be described later. In the fifth line, activation of form is described. When this form is activated, a dialogue of the chatbot that transmits an inquiry to the user for a slot defined in a form is started. When the answers for all the slots are completed, the form ends. The form and slot will be described later. The 13th line and the subsequent lines are descriptions executed when the form ends. In the 13th, 15th, and 17th lines, execution of processing (response) for outputting, to a screen, a character string of a natural language expression indicating that the chatbot generates a script is described. The response will be described later. In the 14th, 16th, and 18th lines, execution of an action code for generating a script is described. Details of the action code will be described later. In the example of FIG. 5, the scenario definition 21a is set to be in the YAML format, but may be in another format such as the JSON format.

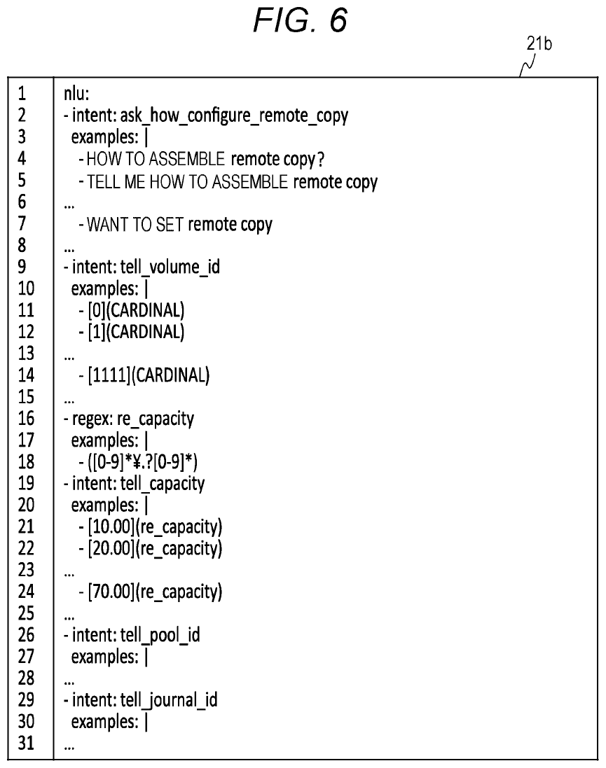

FIG. 6 is a configuration diagram of an example of the intent definition according to the first embodiment.

The intent definition 21b is used by the NLU 47a to understand a character string of the natural language expression input by the user. In the intent definition 21b illustrated in FIG. 6, in the fourth to eighth lines, a plurality of definitions of intent of the user who intends to set remote copy are described. By learning this description, the NLU 47a identifies that the intent is ask_how_configure_remote_copy, when the user inputs a character string that is the same as or close to the natural language expressions. In the ninth to 15th lines, another definition of intent is described. In the 16th to 18th lines, the definition of intent using a regular expression is described. The definition of intent using the regular expression is intent identified by the NLU 47a when the user inputs a value matching the regular expression as an input value. In the other lines, the definition of intent is described by the same or applied method as described above. Although the intent definition 21b is in the YAML format in the example of FIG. 6, the intent definition 21b may be in another format such as the JSON format.

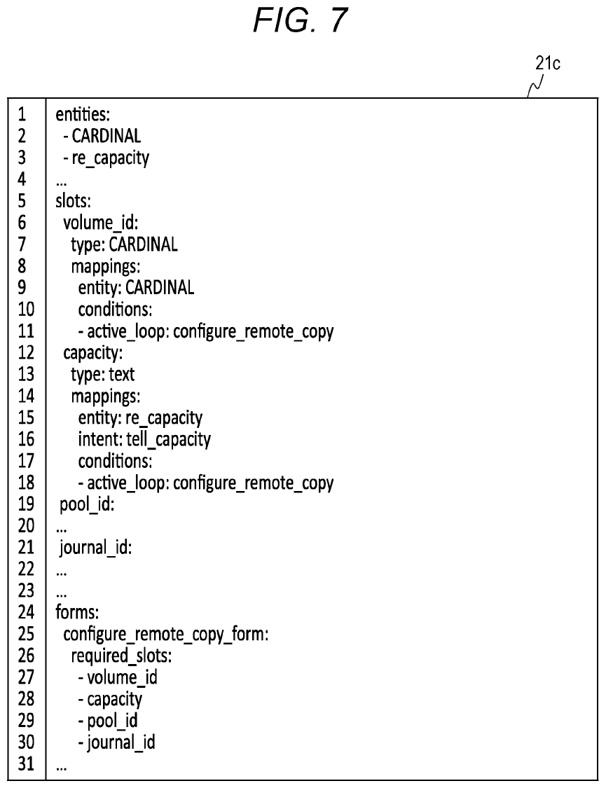

FIG. 7 is a configuration diagram of an example of the Entity·slot definition according to the first embodiment.

The Entity·slot definition 21c is used for the NLU 47a to extract a specific object from a character string of a natural language expression input by the user and store the extracted object in a variable. Here, the entity indicates a type of a target object, and the slot indicates a region for storing the object. For example, when the user inputs “please give a volume of 100 GB”, the NLU 47a can extract “100” as an entity and store the extracted data in a slot called a capacity. The value stored in the slot can be referred to as a variable from the action code 22.

In the Entity·slot definition 21c illustrated in FIG. 7, a definition of entity is described in the second to third lines. CARDINAL represents an entity of an integer type. re_capacity represents that intent defined in the 16th line of the intent definition 21b illustrated in FIG. 6 is referred to as an entity. In the sixth to 22nd lines, definitions of slots of a plurality of variables are described.

The Dialogue management 47b transmits an inquiry to the user so that the value to be stored in the slot can be input according to the context of the dialogue with the user. The Dialogue management 47b uses forms as a determination criterion of the context.

In the Entity·slot definition 21c illustrated in FIG. 7, the 27th to 30th lines, configure_remote_copy_form, that is, a definition of a form for setting remote copy is described. This description indicates that the form for setting remote copy needs slots such as volume_id, capacity, pool_id, and journal_id. When configure_remote_copy_form is activated, the chatbot outputs, to the user, a response for transmitting an inquiry of these slots to the user. A specific example of the dialogue in which the chatbot transmits an inquiry of the slot to the user will be described later. Although omitted in FIG. 7 for simplicity, other entities and slots may be defined by a similar method. Although the Entity·slot definition 21c is in the YAML format in the example of FIG. 7, the Entity·slot definition may be in another format such as the JSON format.

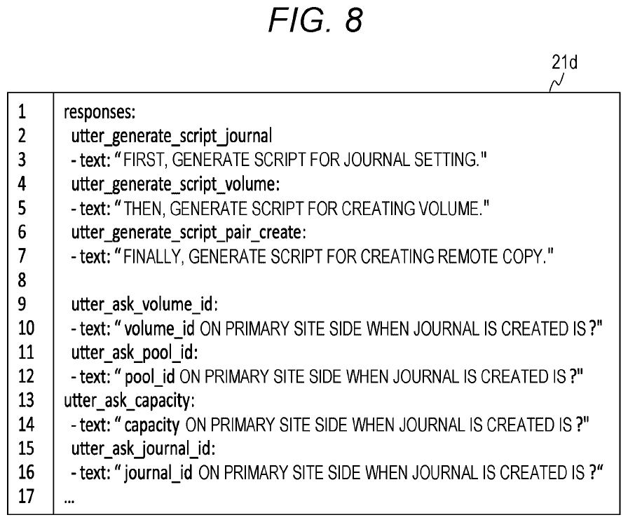

FIG. 8 is a configuration diagram of an example of the response definition according to the first embodiment.

The response definition 21d is a definition of response that is a sentence in a natural language format output from the chatbot to the user. In the response definition 21d illustrated in FIG. 8, the respective names of responses are described in the second, fourth, sixth, ninth, 11th, 13th, and 15th lines, and actual sentences of the response are described in the third, fifth, seventh, tenth, 12th, 14th, and 16th lines. Although omitted in FIG. 8 for simplicity, other responses may be defined by a similar method. Although the response definition 21d is in the YAML format in the example of FIG. 8, the response definition may be in another format such as the JSON format.

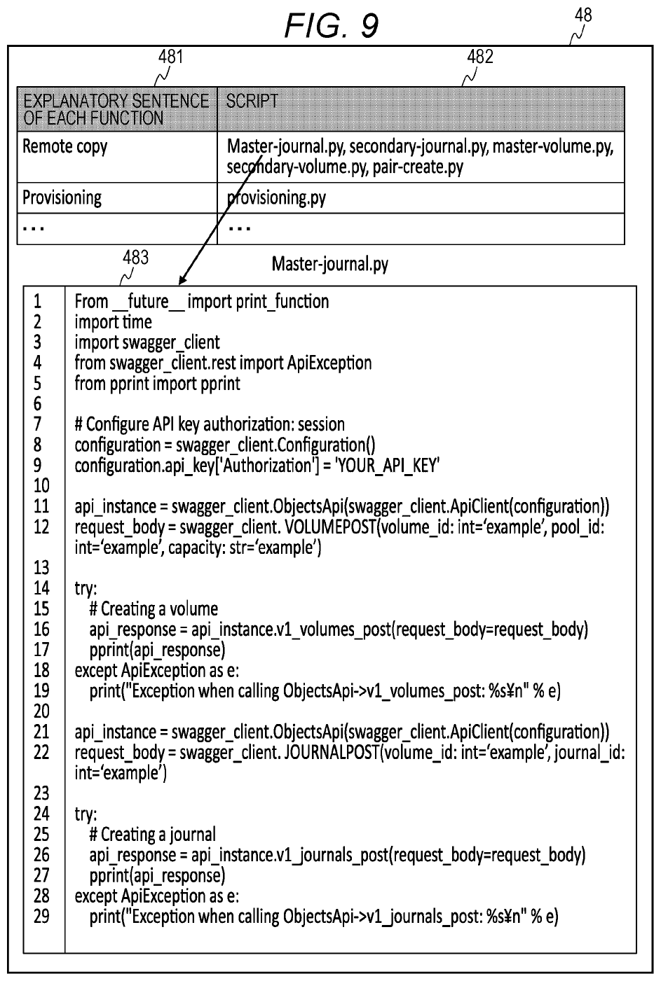

FIG. 9 is a configuration diagram of an example of the script database according to the first embodiment.

The script database 48 is created, for example, in the Bot construction processing. The script database 48 stores an entry for each function (high-level function) of the device.

The entry of the script database 48 includes a key 481 and a value 482. In the key 481, an explanatory sentence (for example, the function name) of a function corresponding to an entry, which is a key, is stored. In the present embodiment, the explanatory sentence of the function may be a value obtained by vectorizing a character string of a natural language expression of the function name.

In the value 482, a script (high-level function script) that is a value and executes the function corresponding to the entry is stored. In the present embodiment, one or more scripts for executing a plurality of low-level functions (middle-level function and/or low-level function: functions of middle classification and/or small classification) constituting the high-level function (function of large classification) corresponding to the entry are stored in the value 482. The script stored in the value 482 may be a script obtained by merging a plurality of API codes for a plurality of functions constituting the high-level function, or may be a script obtained by merging a plurality of API codes of the low-level function (function of small classification) for each of a plurality of middle-level functions (functions of middle classification: also referred to as low-level functions with respect to the high-level function) constituting the high-level function. In short, the script only needs to include a script obtained by merging at least some of codes for setting a plurality of functions constituting the high-level function. For example, a script (master-journal.py, secondary-journal.py, master-volume.py, secondary-volume.py, pair-creat.py) for each of five middle-level functions constituting Remote copy is stored in the value 482 of the first entry. In at least one script of the middle-level function, a plurality of API codes for executing each of a plurality of low-level functions are merged. For example, in master-journal.py illustrated in FIG. 9, import of a necessary library is described in the first to fifth lines, a code for using an authentication and authorization mechanism of a device that executes an API is described in the seventh to ninth lines, setting of an API instance for volume creation and setting of a parameter of a request body are described in the 11th to 12th lines, a code for actually executing an API for volume creation (low-level function) is described in the 14th to 19th lines, setting of an API instance for journal creation and setting of a parameter of a request body are described in the 21st and 22nd lines, and a code for actually executing an API for journal creation (low-level function) is described in the 24th to 29th lines. The code of master-journal.py illustrated in FIG. 9 is an example, and other codes may be used.

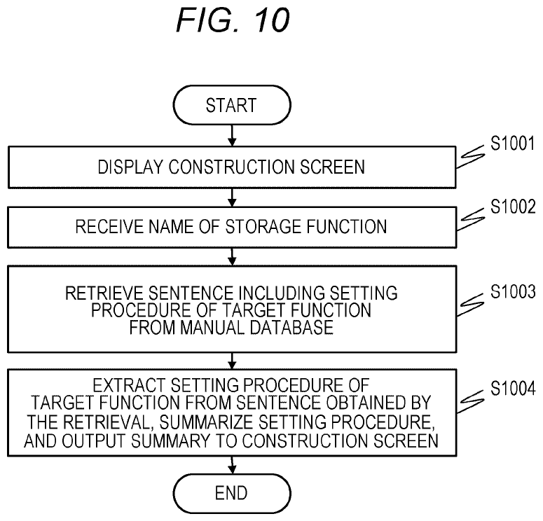

FIG. 10 is a flowchart of setting procedure extraction processing according to the first embodiment.

The manual retrieval program 41 (strictly speaking, the CPU 30 that executes the manual retrieval program 41) displays a construction screen (S1001). The display destination of the construction screen may be the computing machine 1 or a terminal of a user connected to the computing machine 1 via a network. The construction screen may be in a chat format, a CLI format, or a GUI format.

Then, the manual retrieval program 41 receives a sentence (character string) in a natural language format regarding a desired function (target function) of the storage device from the user via the construction screen (S1002). The received sentence may be a name of a storage function.

Then, the manual retrieval program 41 retrieves a sentence including the setting procedure of the target function by retrieval from the manual database 42 based on the received sentence in the natural language format (S1003). Here, the manual retrieval program 41 vectorizes the received sentence in the natural language format and inputs the vector value to the manual database 42. The manual database 42 specifies a key having a high similarity to the input vector value and outputs a manual sentence of the value corresponding to the specified key. As a method of calculating the similarity of the vector value, for example, an approximate nearest neighbor search may be used, or any other similarity calculation algorithm may be used.

Then, the procedure extraction generation AI program 43 receives the manual sentence from the manual retrieval program 41, extracts the setting procedure of the target function from the received manual sentence, and outputs the setting procedure to the construction screen in the itemized form (S1004). According to this construction screen, the user can easily ascertain the setting procedure for setting the target function.

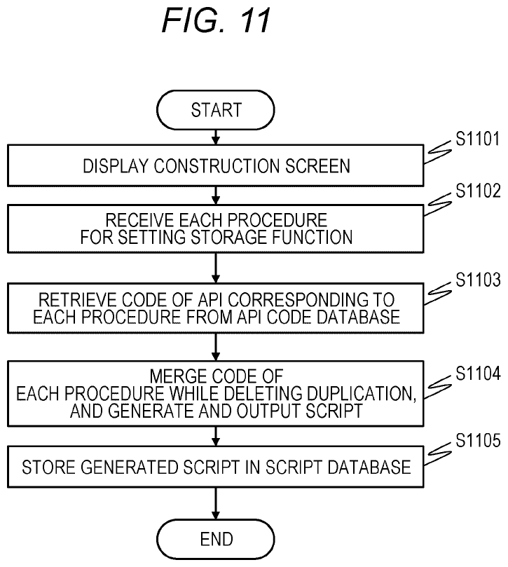

FIG. 11 is a flowchart of script generation processing according to the first embodiment.

The script generation processing is performed subsequent to the setting procedure extraction processing, for example.

The script generation program 44 (strictly speaking, the CPU 30 that executes the script generation program 44) displays the construction screen created in step S1004 of the setting procedure extraction processing (S1101).

Then, the script generation program 44 receives a sentence of a natural language expression of each setting procedure for setting a predetermined storage function (target function) from the user (S1102). Here, the script generation program 44 may receive the sentence of the setting procedure displayed on the construction screen as it is in accordance with an instruction of the user, or may receive the sentence of the setting procedure, which is obtained by the user modifying the setting procedure displayed on the construction screen.

Then, the API code retrieval program 44a retrieves the API code corresponding to each setting procedure from the API code database 44b based on the input sentence of the natural language expression of each setting procedure (S1103). Specifically, the API code retrieval program 44a vectorizes the received sentence of the natural language expression, and inputs the vector value to the API code database 44b. The API code database 44b specifies a key having a high similarity to the input vector value and outputs an API code that is the value corresponding to the specified key. As a method of calculating the similarity of the vector value, for example, an approximate nearest neighbor search may be used, or any other similarity calculation algorithm may be used.

Then, the code merge generation AI program 44c receives the API code of each setting procedure as an input value, generates a script by merging the input API code while deleting duplication, and outputs a URL that can refer to the generated script to the construction screen (S1104). The script itself may be output to the construction screen instead of the URL of the script.

Then, the code merge generation AI program 44c stores the generated script in the script database 48 (S1105). At this time, the Key when stored in the script database 48 may be, for example, a value obtained by vectorizing a character string of a natural language expression of the name of the target function. For example, in a case where the target function is remote copy, “remote copy”may be vectorized as a vector value.

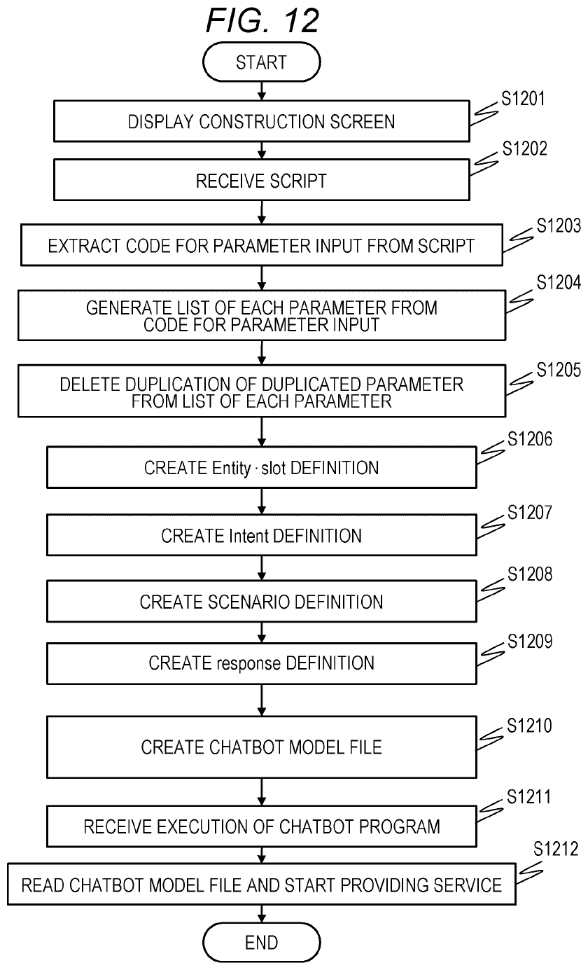

FIG. 12 is a flowchart of chatbot setting processing according to the first embodiment.

The chatbot setting processing is performed subsequent to the script generation processing, for example.

The setting file generation program 45 displays the construction screen output in step S1104 of the script generation processing (S1201).

Then, the setting file generation program 45 receives a script for setting a predetermined function (target function) as a target for constructing a chatbot via the construction screen (S1202). The setting file generation program 45 may receive the script by designating a script name for setting the target function, or may directly receive the script.

Then, the setting file generation program 45 analyzes the received script and extracts a code for parameter input of each API (S1203). For example, in a case where the received script is master-journal.py illustrated in FIG. 9, the setting file generation program 45 extracts, for example, request_body=swagger_client.

VOLUMEPOST(volume_id: int=‘example’, pool_id: int=‘example’, capacity: str=‘example’) in the 12th line and extracts request_body=swagger_client. JOURNALPOST(volume_id: int=‘example’, journal_id: int=‘example’) in the 22nd line.

Then, the setting file generation program 45 creates list information including each parameter from the code for parameter input (S1204). For example, in a case where the received script is master-journal.py illustrated in FIG. 9, list information including volume_id, pool_id, capacity, volume_id, and journal_id is created from the code extracted in step S1203.

Then, the setting file generation program 45 deletes duplication of duplicated parameters from the list information of the parameters (S1205). In the example of the list information described above, since volume_id is duplicated, one volume_id is deleted, and volume_id, pool_id, capacity, and journal_id remain in the list information.

The setting file generation program 45 creates the entity·slot definition 21c from the list information of the parameter (S1206). For example, since volume_id in the list information described above is an int type, in the entity·slot definition 21c, as illustrated in FIG. 7, type is CARDINAL, and type is text since Capacity is a str type. Other entities and slots are similarly created.

The setting file generation program 45 creates the intent definition 21b from the list information of the parameter (S1207). For example, templates such as “how to assemble <function name>? ”, “tell me how to assemble <function name>”, and “want to set <function name>” are prepared in advance in the setting file generation program 45 in advance. The setting file generation program 45 generates the definition of ask_how_configure_remote_copy in the intent definition 21b illustrated in FIG. 6 by replacing <function name>in the template with the name of the target function. For other intents, the template of the intent definition is prepared in the content of the setting file generation program 45, and each definition can be generated by replacing a part of the template with the target of the intent (for example, “volume_id”, “capacity”, and the like) by the similar method. A method of creating the intent definition is not limited thereto, and the intent definition may be created by using another method.

The setting file generation program 45 creates the scenario definition 21a from the information of the middle-level function (middle classification) constituting the target function (S1208). For example, in a case where the setting procedure of the remote copy function received in step S1102 includes the middle-level functions of “journal creation”, “volume creation”, and “pair creation”, the setting file generation program 45 creates a scenario for generating each script as described in the 13th to 18th lines in the scenario definition 21a of FIG. 5. A method of creating the scenario is not limited thereto, and other methods may be used.

Then, the setting file generation program 45 creates the response definition 21d from the information of the middle-level function (middle classification) constituting the target function (S1209). For example, in a case where the setting procedure of the remote copy function received in step S1102 includes the middle-level functions of “journal creation”, “volume creation”, and “pair creation”, the setting file generation program 45 generates a description of the second to seventh lines in the Response definition 21d of FIG. 8. The setting file generation program 45 generates a description of the ninth to 16th lines in the Response definition 21d of FIG. 8 based on the list information of the parameter.

Then, the setting file generation program 45 creates the chatbot model file 23 using the intent definition 21b, the entity·slot definition 21c, and the scenario definition 21a (S1210).

Then, when receiving an instruction to execute the chatbot program 47 from the user (S1211), the CPU 30 activates the chatbot program 47. The activated chatbot program 47 reads the chatbot model file 23 and starts providing a chatbot service (S1212).

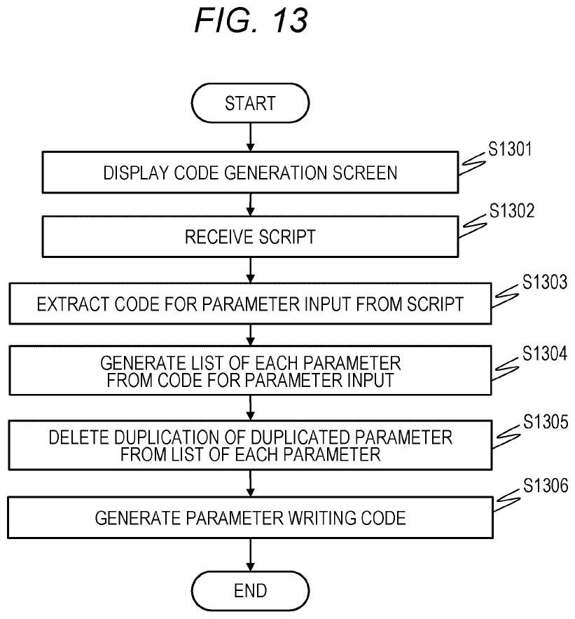

FIG. 13 is a flowchart of action code generation processing according to the first embodiment.

The action code generation processing is performed, for example, after the script generation processing.

The action code generation program 46 displays a code generation screen (S1301). Here, the code generation screen may be a screen similar to the construction screen output in step S1104 of the script generation processing.

Then, the action code generation program 46 receives a script for setting a predetermined function (target function) as a target for constructing the chatbot from the code generation screen (S1302). The action code generation program 46 may receive the script by designating a script name for setting the target function, or may directly receive the script.

Then, the action code generation program 46 executes processes of steps S1303 to S1305 (processes similar to steps S1203 to S1205).

Then, the action code generation program 46 generates a parameter writing code (S1306). Here, the parameter writing code is a code for performing processing of replacing a code related to a parameter in the script for setting the target function with a code in which a value that is acquired by the chatbot from the user and is stored in Slot is input as the setting value of the parameter. The parameter writing code is, for example, a code for performing processing of replacing a code of volume_id: int=‘example’ in the 12th line in master-journal.py illustrated in FIG. 9 with a code of volume_id: int=111 when the value of the slot acquired by the chatbot from the user is 111.

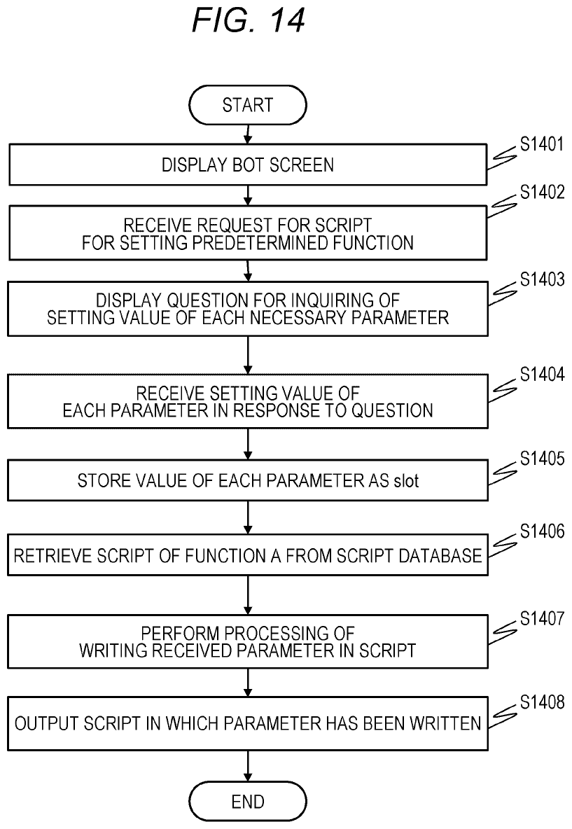

FIG. 14 is a flowchart of chatbot processing according to the first embodiment.

The chatbot processing is processing performed in a case where the chatbot program 47 is activated.

The chatbot program 47 displays a bot screen (S1401).

Then, the chatbot program 47 receives a request for a script for setting a predetermined function (target function) from the user (S1402). In the present embodiment, the chatbot program 47 receives, as an input value, a sentence of a natural language expression (an example of high-level function specifying information) indicating that the script for setting the target function is desired.

The chatbot program 47 displays a question for transmitting, to the user, an inquiry of each parameter necessary for setting the target function on the bot screen (S1403).

Then, the chatbot program 47 receives an answer to the question, that is, the setting value of each parameter as a value of the natural language expression (S1404).

Then, the chatbot program 47 stores the setting value of each parameter received from the user in each slot (S1405).

Then, the script retrieval program 49 retrieves the script for setting the target function from the script database 48 (S1406).

Then, by executing the action code 22 corresponding to the target function, the parameter writing program 50 performs processing of writing the setting value of each parameter stored in Slot in the script obtained in step S1406 (S1407).

Then, the chatbot program 47 outputs a URL that can refer to the script (script for execution) in which the setting value of the parameter has been written, to the bot screen (S1408). The script itself may be output to the bot screen instead of the URL of the script.

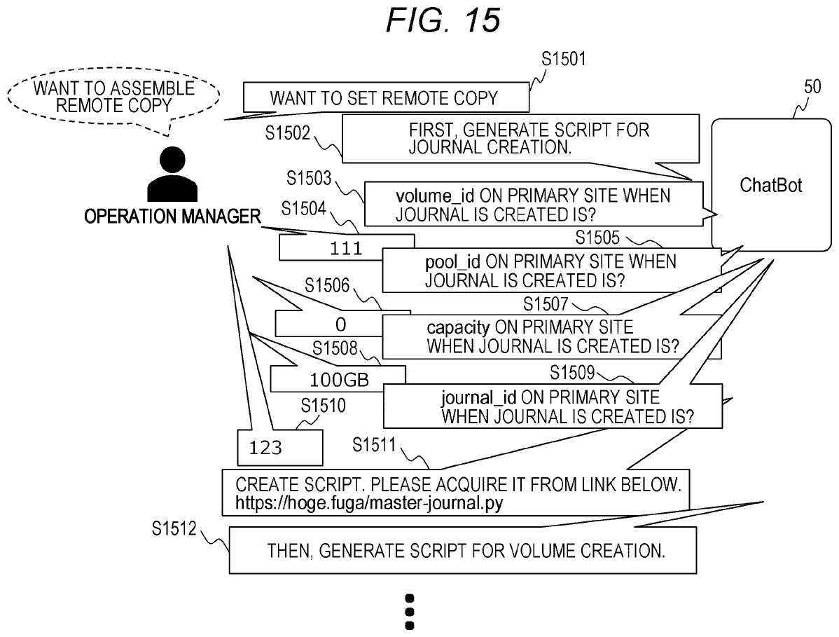

FIG. 15 is a diagram illustrating a dialogue between the operation manager and the chatbot according to the first embodiment.

FIG. 15 illustrates a dialogue between the operation manager who intends to set the remote copy function and the chatbot. Specifically, when the operation manager inputs “I want to set remote copy” (S1501), the chatbot transmits an inquiry of a series of slots, that is, setting values of parameters necessary for the script in responses to the input, and receives an answer from the operation manager (S1502 to S1510). The Slot of which the inquiry is transmitted is volume_id, pool_id, capacity, and journal_id.

In a case where all the Slot answers have been obtained, the chatbot program 47 performs the chatbot processing illustrated in FIG. 14 and outputs “I created a script. Please acquire it from the link below. https: //hoge.fuga/master-journal.py” (S1511). The operation manager can obtain the script for setting the target function by clicking the displayed link. Here, a method of outputting the script is not limited to presenting the link, and the content of the script may be directly displayed on the screen. In a case where there are a plurality of scripts of the middle-level functions as the script necessary for the function setting of remote copy, similar processing is performed for each script. As a result, it is possible to create all scripts of the middle-level functions necessary for setting the high-level function.

As described above, according to the computing machine 1 according to the first embodiment, the operation manager can easily and appropriately generate the script for setting the desired function even though the operation manager is not familiar with the setting procedure for setting the desired function.

### Second Embodiment

Next, a computing machine according to a second embodiment will be described.

The second embodiment is different from the first embodiment in the following points. In the present embodiment, without using the procedure extraction generation AI program 43, the construction manager directly inputs information (setting procedure information) of a setting procedure for setting a desired function to the computing machine. In Bot construction processing, script generation processing, setting file generation processing, and action code generation processing are performed based on the input setting procedure information. In the following description, parts having differences from the first embodiment will be mainly described, and description of parts having overlapping contents may be omitted.

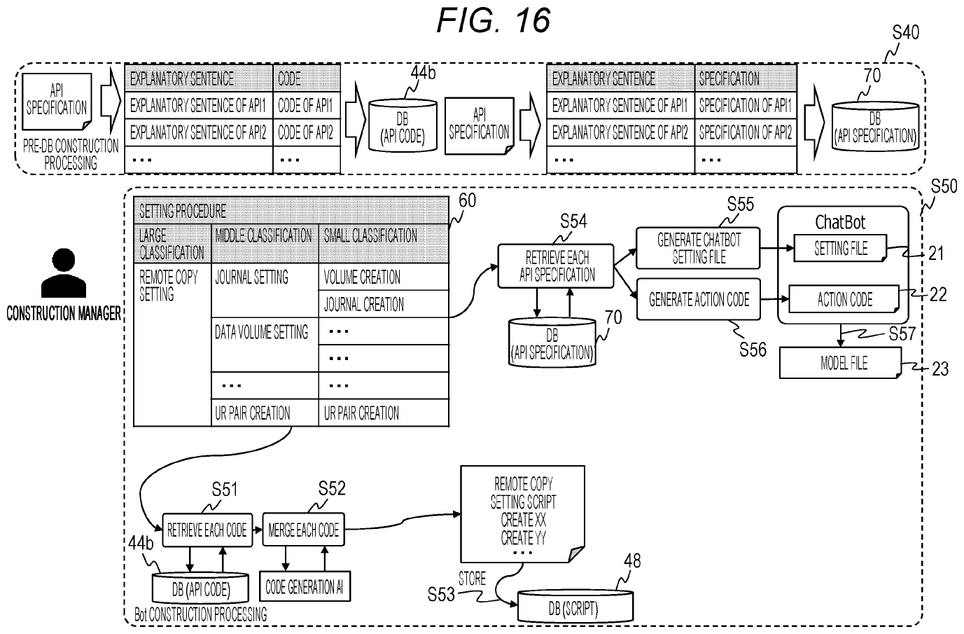

FIG. 16 is a diagram illustrating an outline of processing of the computing machine according to the second embodiment.

The computing machine according to the second embodiment is different from the first embodiment in pre-DB construction processing and Bot construction processing.

In pre-DB construction processing S40, an API code database 44b and an API specification database 70 are constructed. Since the processing of constructing the API code database 44b is the same as that in the first embodiment, the description thereof will be omitted.

The API specification database 70 is, for example, a database that manages a set of a key and a value, the key is an API explanatory sentence, and the value is information regarding the specification of the API corresponding to the API explanatory sentence of the key.

Although the API explanatory sentence is illustrated as an explanatory sentence of a natural language expression in FIG. 16, for example, the explanatory sentence of the natural language expression may be a numerical value obtained by vectorization using a predetermined language model. Here, as the language model, Word2Vec, BERT, text-embedding-ada-002 can be used, and other existing language models or newly developed language models may be used.

In Bot construction processing S50, the computing machine receives setting procedure information in an itemized form from the construction manager via the construction screen. The setting procedure information may be structured to have a plurality of hierarchies (classifications) as illustrated in FIG. 16. An example of the setting procedure information will be described later. In the Bot construction processing S50, the computing machine 1 generates a template of a script for executing each setting procedure for setting a function based on the received setting procedure information (S51 and S52), and stores the template in a script database 48 (S53).

Then, the computing machine retrieves a specification of each API for setting each function from the API specification database 70 based on the received setting procedure in the itemized form (S54). Then, the computing machine generates and outputs a chatbot setting file 21 and an action code 22 based on the specification of each API (S55 and S56). The computing machine generates a chatbot model file 23 from the chatbot setting file 21 (S57).

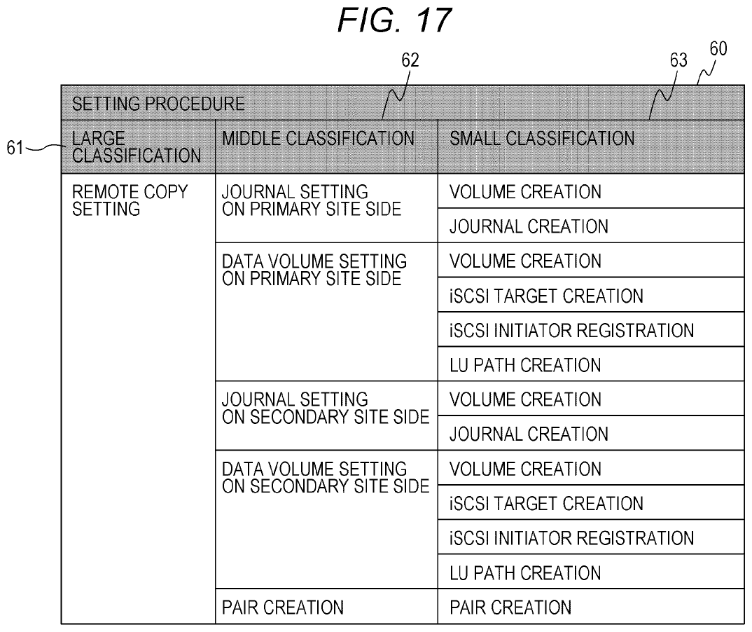

FIG. 17 is a configuration diagram of the setting procedure information according to the second embodiment.

The setting procedure information 60 has, for example, a hierarchical structure including a large classification 61, a middle classification 62, and a small classification 63.

In the large classification 61, a function (high-level function) for which the operation manager requests a script is stored. In the example of FIG. 17, remote copy setting is stored. In the middle classification 62, a middle-level function constituting the high-level function is stored. In the example of FIG. 17, five middle-level functions of journal setting on a primary site side, data volume setting on the primary site side, journal setting on a secondary site side, data volume setting on the secondary site side, and pair creation are stored as the middle-level functions. In the present embodiment, a script is generated in units of the middle-level function. In the small classification 63, a low-level function constituting the middle-level function is stored. The low-level function is, for example, a minimum unit of the API. In the present embodiment, the middle-level function has one or more low-level functions. In a script for setting the middle-level function including a plurality of low-level functions, a plurality of APIs for setting the plurality of low-level functions are executed.

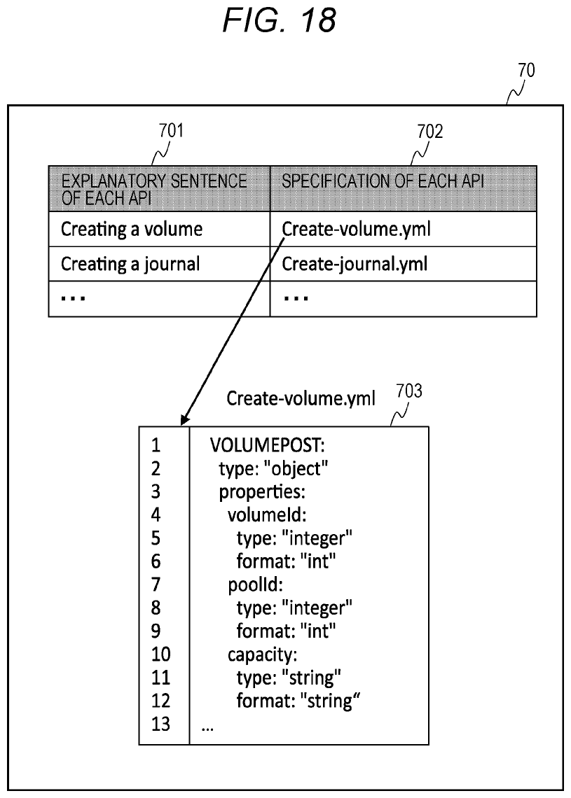

FIG. 18 is a configuration diagram of an example of an API specification database according to the second embodiment.

The API specification database 70 is created, for example, in the pre-DB construction processing. The API specification database 70 stores an entry for each API.

The entry of the API specification database 70 includes a key 701 and a value 702. The key 701 stores an explanatory sentence of an API corresponding to an entry, which is a key. In the present embodiment, the explanatory sentence of the API may be a value obtained by vectorizing a character string of a natural language expression of the explanatory sentence of the API. The explanatory sentence of the API may be a summary in the API specification 24.

For example, regarding the API for POST of /v1/volumes of the API specification 24 in FIG. 3, the value in the 11th line may be used. Information other than the summary may be used as the explanatory sentence of the API.

The value 702 stores the specification of the API corresponding to the entry, which is a value. The specification of the API may be information regarding a parameter for executing the API. For example, the API for POST of /v1/volumes of the API specification 24 in FIG. 3 may be values in the 26th to 38th lines. For example, a file 703 of a code whose file name is Create-volume.yml is stored in the value 702 in the first entry.

In the file 703, a parameter name of volumeId is described in the fourth line, and it is described in the fifth line that the type of this parameter is integer.

Other parameters are similarly described. The information regarding the specification of each API is not limited to the information of the parameter in the API specification conforming to SWAGGER, and may be information regarding any other API specification. In the example illustrated in FIG. 18, the information regarding the API specification is in the Yaml format, but the present embodiment is not limited thereto, and may be in any format such as the JSON format.

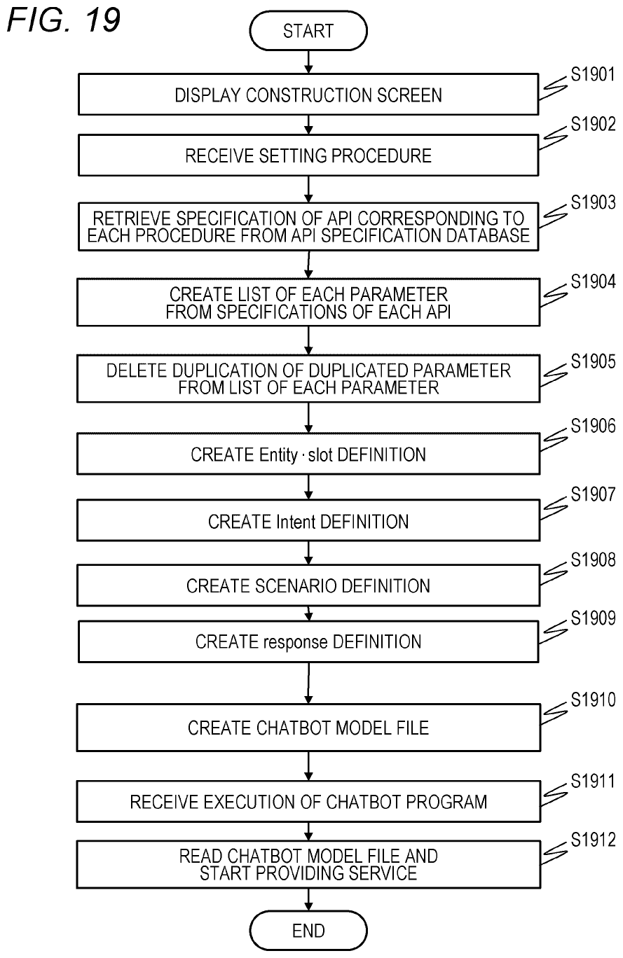

FIG. 19 is a flowchart of chatbot setting processing according to the second embodiment.

A setting file generation program 45 displays a construction screen (S1901). Then, the setting file generation program 45 receives setting procedure information 60 of a target function via the construction screen (S1902).

Then, the setting file generation program 45 retrieves, from the API specification database 70, each setting procedure of the setting procedure information 60, that is, specification information of the API corresponding to the setting procedure of the small classification in FIG. 17 (S1903).

Then, the setting file generation program 45 creates list information of each parameter in units of scripts to be generated, that is, in units of the middle classification in FIG. 17 (S1904). For example, for the “. . . journal setting” in the setting procedure information 60 illustrated in FIG. 17, list information including volume_id, pool_id, capacity, volume_id, and journal_id is created from the specification information (for example, the code of the parameter) of the API extracted in S1903.

Then, the setting file generation program 45 deletes duplication of duplicated parameters from the list information of the parameters (S1905). For example, regarding the “. . . journal setting” in the setting procedure information 60 illustrated in FIG. 17, since volume_id is duplicated, one volume_id is deleted, and volume_id, pool_id, capacity, and journal_id remain in the list information.

The setting file generation program 45 creates the entity·slot definition 21c from the list information of the parameter (S1906). For example, since volume_id in the list information described above is an int type, in the entity·slot definition 21c, as illustrated in FIG. 7, type is CARDINAL, and type is text since Capacity is a str type. Other entities and slots are similarly created.

The setting file generation program 45 creates the intent definition 21b from the list information of the parameter (S1907). For example, templates such as “how to assemble <function name>? ”, “tell me how to assemble <function name>”, and “want to set <function name>” are prepared in advance in the setting file generation program 45 in advance. The setting file generation program 45 generates the definition of ask_how_configure_remote_copy in the intent definition 21b illustrated in FIG. 6 by replacing <function name>in the template with the name of the target function. For other intents, the template of the intent definition is prepared in the content of the setting file generation program 45, and each definition can be generated by replacing a part of the template with the target of the intent (for example, “volume_id”, “capacity”, and the like) by the similar method. A method of creating the intent definition is not limited thereto, and the intent definition may be created by using another method.

The setting file generation program 45 creates the scenario definition 21a from the information of the middle-level function (middle classification) constituting the target function (S1908). For example, in a case where the setting procedure information of a remote copy function received in step S1902 includes the middle-level functions of “journal creation”, “volume creation”, and “pair creation”, the setting file generation program 45 creates a scenario for generating each script as described in the 13th to 18th lines in the scenario definition 21a of FIG. 5. A method of creating the scenario is not limited thereto, and other methods may be used.

Then, the setting file generation program 45 creates the response definition 21d from the information of the middle-level function (middle classification) constituting the target function (S1909). For example, in a case where the setting procedure information of the remote copy function received in step S1902 includes the middle-level functions of “journal creation”, “volume creation”, and “pair creation”, the setting file generation program 45 generates a description of the second to seventh lines in the Response definition 21d of FIG. 8. The setting file generation program 45 generates a description of the ninth to 16th lines in the Response definition 21d of FIG. 8 based on the list information of the parameter.

Then, the setting file generation program 45 creates the chatbot model file 23 using the intent definition 21b, the entity·slot definition 21c, and the scenario definition 21a (S1910).

Then, when receiving an instruction to execute a chatbot program 47 from the user (S1911), the CPU 30 activates the chatbot program 47. The activated chatbot program 47 reads the chatbot model file 23 and starts providing a chatbot service (S1912).

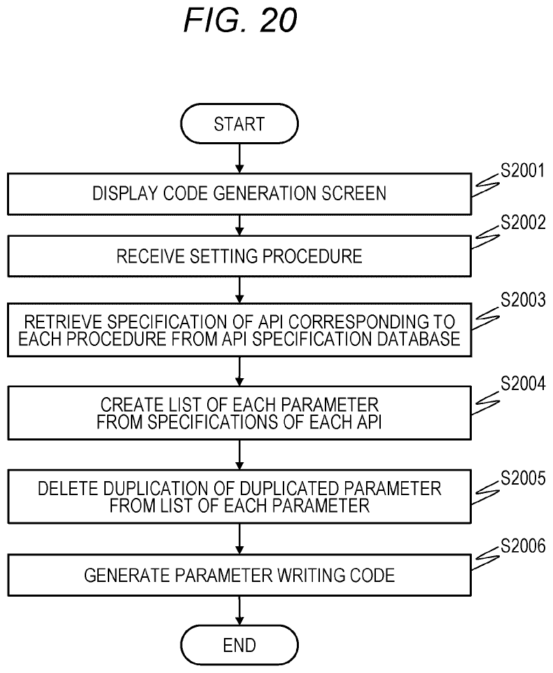

FIG. 20 is a flowchart of action code generation processing according to the second embodiment.

The action code generation program 46 displays a code generation screen (S2001).

Then, an action code generation program 46 receives setting procedure information of a predetermined function (target function) as a target for constructing the chatbot from a code generation screen (S2002).

Then, the action code generation program 46 executes processes of steps S2003 to S2005 (processes similar to steps S1903 to S1905).

Then, the action code generation program 46 generates a parameter writing code (S2006). Here, the parameter writing code is a code for performing processing of replacing a code related to a parameter in the script for setting the target function with a code in which a value that is acquired by the chatbot from the user and is stored in Slot is input as the setting value of the parameter. The parameter writing code is, for example, a code for performing processing of replacing a code of volume_id: int=‘example’ in the 12th line in master-journal.py illustrated in FIG. 9 with a code of volume_id: int=111 when the value of the slot acquired by the chatbot from the user is 111.

As described above, according to the computing machine according to the second embodiment, the operation manager can easily and appropriately generate the script for setting the desired function even though the operation manager is not familiar with the setting procedure for setting the desired function.

The present invention is not limited to the above-described embodiments, and can be appropriately modified and implemented in a range without departing from the gist of the present invention.

What is claimed is:

1. A script generation apparatus that generates a script for setting a predetermined high-level function for a predetermined device, the script generation apparatus comprising:
a storage and a processor, wherein
the storage is configured to
store a database that stores codes of a plurality of APIs for setting each of a plurality of functions, and
the processor that has received, from a user, a request for setting of a high-level function realized by using a plurality of low-level functions is configured to
retrieve and acquire codes of a plurality of APIs used for setting a plurality of low-level functions in response to the request from the database,
create a high-level function script for setting the high-level function by using the acquired codes of the plurality of APIs, and
set a parameter of the high-level function script based on an input of the user, and issue the high-level function script.

2. The script generation apparatus according to claim 1, wherein
the storage is further configured to store setting procedure information regarding setting of the device, and
the processor is further configured to
specify the plurality of low-level functions to be used for the high-level function from the setting procedure information.

3. The script generation apparatus according to claim 1, wherein
the processor is further configured to
set a chatbot that has a dialogue with the user, and receive an input of the user for setting the parameter by the dialogue by the chatbot.

4. The script generation apparatus according to claim 2, wherein
the setting procedure information includes
setting of a plurality of middle-level functions used for setting the predetermined high-level function and setting of a low-level function used for setting the middle-level functions.

5. The script generation apparatus according to claim 1, wherein
the processor is further configured to
specify parameters to be used for codes of a plurality of APIs obtained by the retrieval, and exclude duplication for the specified parameters of the plurality of codes, and
acquire, from the user, an input for setting a setting value of the parameter obtained by excluding the duplication.

6. The script generation apparatus according to claim 1, wherein
the processor is further configured to
create a parameter writing code to be written in the parameter of the high-level function script by using the setting value of the parameter.

7. The script generation apparatus according to claim 3, wherein
the processor is further configured to
receive, from a user, high-level function specifying information for specifying a high-level function as a target to be set,
receive an input of a setting value of a parameter to be used in a script for setting a high-level function corresponding to the high-level function specifying information,
retrieve a high-level function script for setting the high-level function corresponding to the high-level function specifying information,
create an execution script by writing the setting value of the parameter received by the chatbot in the high-level function script, and
output the execution script.

8. The script generation apparatus according to claim 1, wherein
the processor is further configured to
specify a plurality of sets, each set including low-level function specifying information for specifying a low-level function and codes of an API for executing setting of the low-level function, from a document in which specifications of a plurality of APIs of the device are described, and store the plurality of sets in the database.

9. A script generation method by a script generation apparatus that generates a script for setting a predetermined high-level function for a predetermined device, the script generation method comprising:
by the script generation apparatus,
receiving, from a user, a request for setting of a high-level function realized by using a plurality of low-level functions, and retrieving and acquiring codes of a plurality of APIs necessary for setting a plurality of low-level functions used for setting the high-level function for the device in response to the request from a database that stores codes of a plurality of APIs for setting each of a plurality of low-level functions;
creating a high-level function script for setting the high-level function by using the acquired codes of the plurality of APIs; and
setting a parameter of the high-level function script based on an input of the user, and issuing the high-level function script.
